(19) United States
(12) Patent Application Publication
(10) Pub. No.: US 2008/0117924 A1
(43) Pub. Date: May 22, 2008

(54) DATA RELAY UNIT

(75) Inventors: Takayoshi Nakamura, Kariya-city (JP); Hiroshi Matsuda, Okazaki-city (JP); Katsuhiko Furuta, Chita-gun (JP); Katsutoshi Haruna, Anjo-city (JP); Akira Kurahashi, Nukata-gun (JP); Keiichi Aoyama, Kariya-city (JP); Daisuke Manabe, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/942,850

(22) Filed: Nov. 20, 2007

(30) Foreign Application Priority Data
Nov. 22, 2006 (JP) 2006-315970

(51) Int. Cl. H04L 12/66

(52) U.S. Cl. 370/401

(57) ABSTRACT

A data relay unit capable of relaying data communication between first and second networks interchanging different structures of data, a gateway (GW) and a method are provided. An identifier is assigned to transmission data and reception data exchanged in a GW unit. A data conversion section specifies a conversion process using reception data for generating transmission data for each transmission data piece identified by an identifier and uses a conversion table to store conversion processes. The data conversion section can generate intended transmission data based on an identifier of the transmission data to be transmitted by selecting and executing a necessary conversion process from the conversion table. Even when a method of generating transmission data is added or changed, it is only necessary to add or change a conversion process in the conversion table.

### CROSS REFERENCE TO RELATED APPLICATIONS

The present application is related to and claims priority from Unpublished Japanese Patent Application No. 2006-315970, the entire contents of which are incorporated herein by reference.

### BACKGROUND OF THE INVENTION

1. Field of the Invention

The present invention relates generally to a data relay unit provided between first and second networks. More specifically, the present invention provides for exchanging different structures of data and relaying data communication between the first and second networks.

2. Description of the Background Art

In accordance with a conventionally known data relay unit as described, for example, in Japanese Patent Unexamined Publication No. JP-A-2004-350138, a reception buffer having multiple buffers for temporarily storing received data; a main buffer including multiple buffers for temporarily storing received data transferred from the reception buffer; and a data controller for transferring data stored in the reception buffer to the main buffer are included. The data controller transfers data stored in the reception buffer in accordance with a specified time interval. When the reception buffer stores a specified amount of data, an interrupt process can be used to transfer data at a time associated with the interrupt. As a result, it is unnecessary to start a transfer process each time data is received. Rather, data can be transmitted at a different time and the data controller can accordingly be relieved of a processing load.

It should be noted that it is possible for the above-mentioned conventional data relay unit to transfer received data without modification because the originating data transmission network and the destination data transmission network are configured to handle the same structure of data.

However, a vehicle is typically mounted with an increasing number of electronic controllers each having a networking capability. One vehicle may construct multiple local area networks that operate according to different structures of communication data. However, under normal circumstances, the use of different data structures makes the intercommunication difficult. A need thus arises for intercommunication between electronic controllers mounted on the same vehicle.

### SUMMARY OF THE INVENTION

The present invention has been made in consideration of the foregoing. It is therefore an object of the present invention to provide a data relay unit capable of relaying data communication between first and second networks interchanging different structures and content of data.

To achieve the above-mentioned object, a data relay unit can include a data conversion section for generating transmission data to be transmitted to one of the first and second networks out of reception data received from the other. A specific identifier is assigned to each of the reception data and the transmission data. The data conversion section specifies a conversion process using the reception data for generating transmission data for each transmission data piece identified by an identifier and uses a conversion table for storing a conversion process corresponding to an identifier of transmission data.

The data conversion section can generate intended transmission data based on an identifier of the transmission data to be transmitted by selecting and executing a conversion process for generating the transmission data from the conversion table. The conversion table stores a collection of conversion processes for generating transmission data. Even when a method of generating transmission data is added or changed, it is only necessary to add or change a conversion process in the conversion table. That is, it is possible to expand the versatility of the data conversion section and decrease the number of steps for constructing the data conversion section.

According to one aspect of the data relay unit, the transmission data includes portions or pieces of individual data. A conversion process for generating the transmission data includes individual conversion processes each specified for the individual data. In other words, the conversion process is categorized into its content and is defined as a set of independently specified individual conversion processes.

For example, transmission data may be generated by extracting part of pieces of reception data and rearranging the data in a given sequence. When the individual conversion process is defined for each reception data to be extracted, each individual conversion process can be defined in terms of an identifier of reception data to be extracted, a position of data to be extracted, and a position of the extracted data in the sequence of transmission data. Dividing the conversion process into individual conversion processes can simplify the content of the individual conversion process, make it understandable, and improve the reusability.

When the conversion process includes a set of individual conversion processes, the data conversion section preferably includes an index that stores an identifier of the transmission data corresponding to an address in the conversion table for storing individual conversion processes for generating the transmission data. The data conversion section can easily use the index to select individual conversion processes corresponding to an identifier of the transmission data to be transmitted from the conversion table.

The data conversion section preferably determines an identifier of transmission data to be transmitted next based on a relay priority of reception data received from one of the first and second networks and based on a transmission result of transmission data. The identifier of the next data transmission format is necessary because some important reception data pieces need to be relayed without delay. As another effect, data can be transmitted at an interval appropriate to each transmission data piece in consideration for a transmission result such as an elapsed time from the most recent transmission time point in terms of respective transmission data pieces.

### BRIEF DESCRIPTION OF THE DRAWINGS

FIG. 1 is a block diagram illustrating an exemplary overall configuration of a network system using a data relay unit in accordance with an embodiment;

FIG. 2 is a flowchart illustrating an exemplary conversion process that is performed in a data conversion section of a gateway (GW) unit and generates transmission data;

FIG. 3 is a diagram illustrating an exemplary index and conversion table used for the conversion process;

FIG. 4 is a diagram illustrating a first conversion example in the exemplary data conversion section;

FIG. 5 is a diagram illustrating a second conversion example in the exemplary data conversion section;

FIG. 6 is a diagram illustrating a illustrating third conversion example in the exemplary data conversion section; and

FIG. 7 is a diagram illustrating a fourth conversion example in the exemplary data conversion section.

### DETAILED DESCRIPTION OF THE PREFERRED EMBODIMENTS

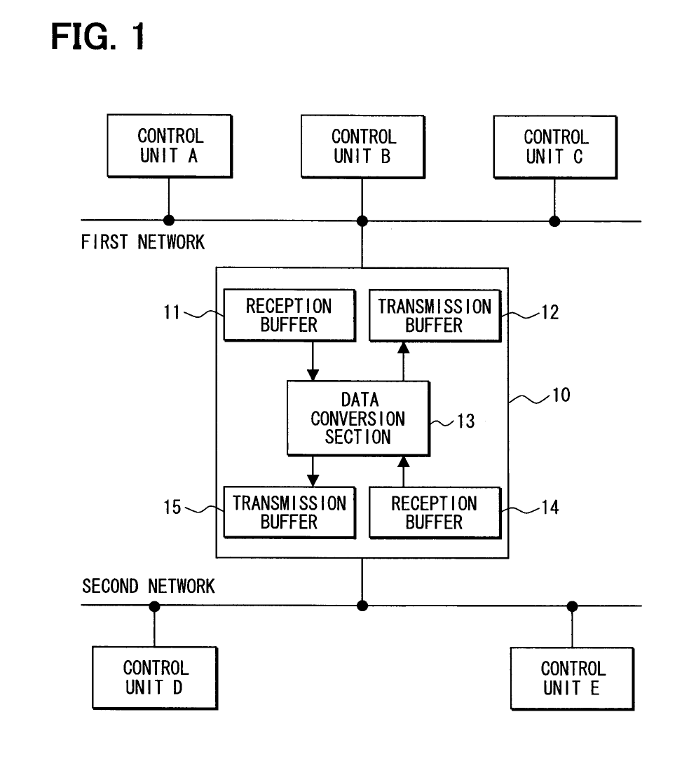

The following describes the data relay unit according to an exemplary embodiment of the invention. The network system as shown in FIG. 1 can be used in, for example, an onboard electronic controller, a home electronic device, or the like. The network system includes a first network connecting with, for example, control units A, B, and C and a second network connecting with, for example, control units D and E. The first and second networks communicate, for example, using different data structures and contents as will be described in greater detail hereinafter.

A gateway (GW) unit 10 is connected as a data relay unit between the first and second networks that communicate using, for example, different data structures that can have, for example, different contents, data types, or the like. The GW unit 10 further includes a reception buffer 11 and a transmission buffer 12. The reception buffer 11 functions as an input/output section for the first network and receives and temporarily stores data transmitted from, for example, the control units A through C belonging to the first network. The transmission buffer 12 contains transmission data generated based on the reception data received by the second network, for example, as stored in reception buffer 14, and transmits the transmission data to the first network. In addition to the reception buffer 14, the GW unit 10 further includes a transmission buffer 15. The reception buffer 14 is used as an input/output (I/O) section associated with the second network and receives and temporarily stores data transmitted from, for example, the control units D and E associated with the second network. The transmission buffer 15 contains data such as transmission data generated based on reception data received by the first network, for example, as stored in reception buffer 11, and transmit the transmission data to the second network.

It should be noted that the control units A through E are configured to transmit transmission data provided with a unique identifier (ID) according to, for example, the type of data including but not limited to the bit resolution of the data, the quantity corresponding to the data such as temperature, and the like.

The reception buffers 11 and 14 in the GW unit 10 contain storage capacities for individually storing transmission data with different identifiers transmitted from the control units A through E associated with the corresponding networks. In some instances, the reception buffers 11 and 14 may receive transmission data whose identifier equals that of reception data that is already stored. In such case, the buffers are configured such that the existing reception data is overwritten with the newly received data. In the above described manner, the reception buffers 11 and 14 always store up-to-date reception data.

The GW unit 10 includes a data conversion section 13 that performs a conversion process for generating transmission data based on reception data stored in the reception buffers 11 and 14. Transmission data generated by the data conversion section 13 is placed in the transmission buffers 12 and 15. When the GW unit is given a transmission right, transmission opportunity, transmission permission, or the like, the transmission buffers 12 and 15 transmit the transmission data to the corresponding networks.

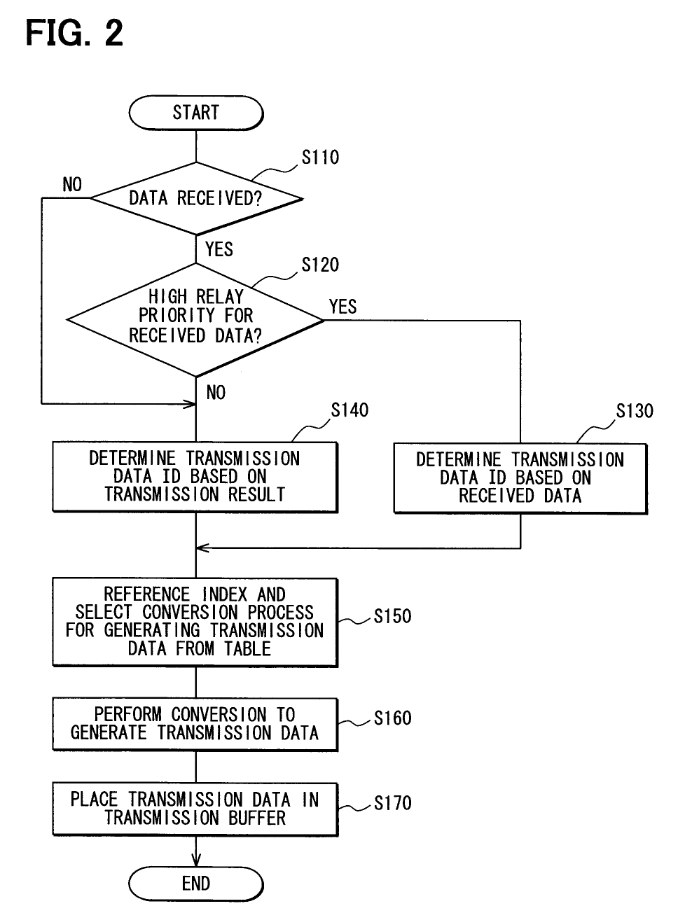

With reference to FIG. 2, a flowchart is shown and described in connection with an exemplary conversion procedure, program, method, process or the like in the data conversion section 13 for generating transmission data. It should be noted that the same concepts and procedures described herein below can be applied to conversion processes for generating transmission data in both the first and second networks. Accordingly, the following description is directed to a method of generating transmission data to be transmitted to one network based on reception data received in the other network, without specific distinction between the first and second networks.

At S110, the exemplary process determines whether the reception buffers 11 and 14 of the GW unit 10 have received new reception data. If it is determined that new reception data has been received, the exemplary process proceeds to S120. If it is determined that new reception data has not been received, the exemplary process proceeds to S140.

As mentioned above, the reception buffers 11 and 14 of the GW unit 10 include storage capacities and capabilities for individually storing multiple pieces of reception data having, for example, different identifiers. The reception buffers 11 and 14 store only that reception data needing to be relayed from one network to the other, that is, reception data used to generate transmission data as determined from the identifiers. The reception buffers 11 and 14 do not store reception data that is determined, based on the identifier, to be unnecessary to be relayed from one network to the other.

At S120, the exemplary process determines whether the reception data is given a high relay priority. The high relay priority is given to important data to be relayed without delay such as data associated with errors and security, or other time-sensitive data. When it is determined at S120 that the reception data is given a high relay priority, the process proceeds to S130. When it is determined that the reception data is not given a high relay priority, the process proceeds to S140.

At S130, the exemplary process determines an identifier of transmission data to be transmitted based on the reception data having a high relay priority so as to generate transmission data for relaying the reception data. When receiving important reception data to be relayed without delay, the data conversion section 13 performs the process for generating transmission data corresponding to the reception data as will be described in greater detail hereinafter.

At S140, the exemplary process determines an identifier of transmission data to be transmitted based on a transmission result of transmission data in the GW unit 10. For example, an identifier of transmission data to be transmitted next can be determined based on an elapsed time from the most recent transmission time point in terms of transmission data having different identifiers. Further, data can be transmitted at an interval appropriate to each transmission data piece in consideration of a transmission result for the transmission data having a specific identifier. At S150, the exemplary process references an index and selects, from a conversion table, a conversion process for generating transmission data having the determined identifier.

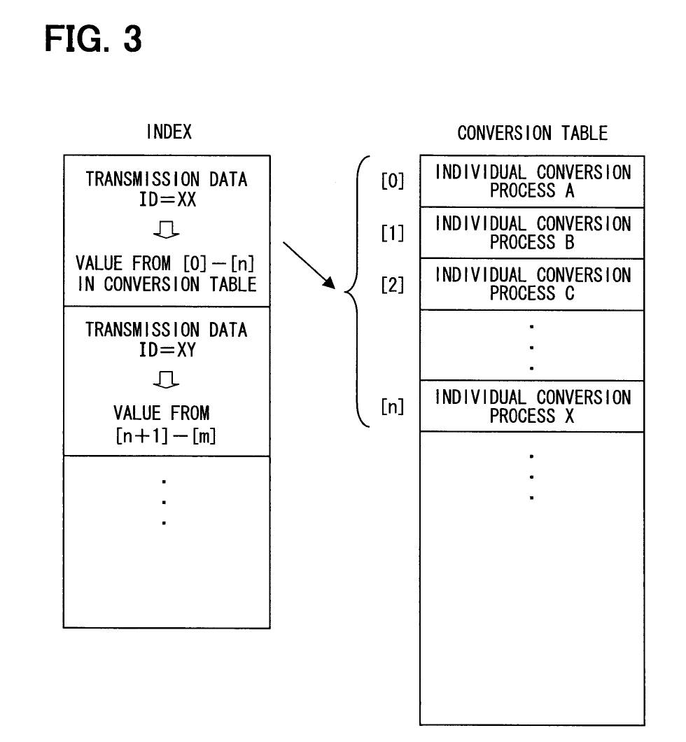

The index and the conversion process will now be described with reference to FIG. 3. As shown, the conversion table can store a collection of conversion processes for generating transmission data of a particular identifier. Thus, when a method of generating transmission data is added or changed, it is only necessary to add or change a corresponding conversion process in the conversion table.

The conversion process for generating transmission data can be further defined as a set of individual conversion processes that are categorized by conversion contents and are specified independently of each other. According to an example in FIG. 3, individual conversion processes A through X are used to generate one piece of transmission data having, for example, an identifier of “XX”.

As will be described in greater detail hereinafter, transmission data may be generated by extracting part of pieces of reception data and rearranging the data in a given sequence. When individual conversion processes are defined for each reception data piece to be extracted, each individual conversion process can be further defined in terms of an identifier of the reception data to be extracted, a position within the reception data of the data piece to be extracted, and a position within the sequence of transmission data that the extracted data piece will occupy. By dividing the conversion process into individual conversion processes the content of the conversion process can be made simple and understandable, and the reusability of the conversion process and individual conversional processes can be improved. It should be noted that for illustrative purposes, data generated by an individual conversion process is referred to as “individual data” in the transmission data.

It should be noted that an exemplary index, for example as shown in FIG. 3, indicates a range of addresses within the conversion table that contains individual conversion processes for generating transmission data corresponding to the transmission data having the corresponding identifier. Thus for transmission data determined to have an identifier “XX,” that is when the index is referenced as shown in FIG. 3, for example, the index specified by identifier “XX” indicates that the individual conversion processes, such as A-X, for generating the transmission data are stored at addresses [0]˜[n] in the conversion table. In accordance with another index, for example in connection with transmission data having an identifier “XY,” a conversion process having a different group of individual conversion processes such as those that are within the specified address range of [n+1]˜[m] of the conversion table is used. It should be noted that while individual conversion processes, such as A-X, stored at addresses [0]˜[n] in the conversion table are described in connection with the index for the XX identifier, some or even all of the individual conversion processes can also be used in connection with conversion of transmission data having the “XY” or other identifier provided the collection of conversion processes is different enough to justify use of a dedicated index for the conversion processing collection. It should be noted that the use of an index and corresponding specific collection of conversion processes makes it possible to easily select a group of individual conversion processes from the conversion table in accordance with an identifier for transmission data to be transmitted.

Return to the flowchart in FIG. 2, at S150, the exemplary process selects a conversion process for generating transmission data by the index procedure as described above. At S160, the exemplary process executes each of the individual conversion processes starting from the base address indicated in the index in order to generate transmission data. At S170, the exemplary process places the transmission data generated at S160 in the transmission buffers 12 and 15, whereupon the transmission data can be transmitted to the corresponding one of the networks, for example, when the GW unit 10 is given a transmission right, opportunity or the like.

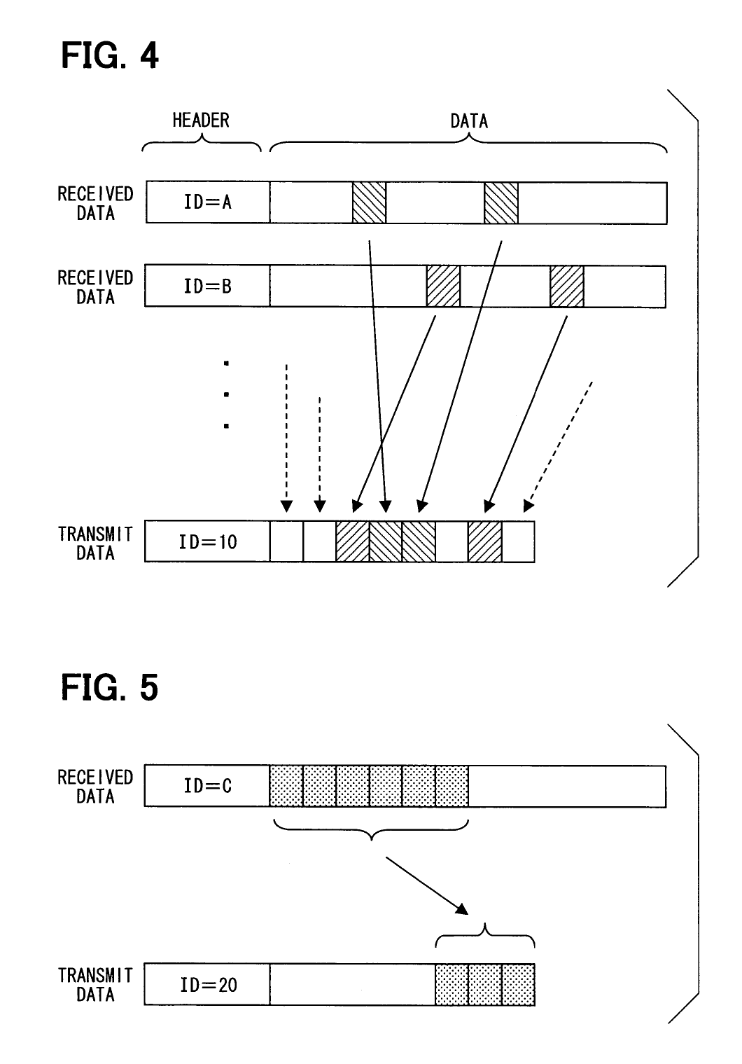

The following describes conversion examples of individual conversion process with reference to FIG. 4 through FIG. 7.

A first conversion example, shown and described in connection with for example in FIG. 4, is an exemplary conversion process for generating transmission data when reception data and transmission data are differently positioned or, to be more specific, data to be transmitted are scattered over multiple pieces of reception data. In the present case, the conversion process specifies specific portions of the reception data with the reception buffer that contain data to be transmitted by reading the identifier and extracting the data pieces at the specified position or location within the reception data where the data pieces or pieces are located. As described above, the location or position of the data pieces is also associated with the identifier of the data within the specified reception data. The conversion process rearranges the extracted data in a predetermined sequence to generate the transmission data.

As mentioned above, the first conversion example defines the individual conversion processes using identifiers for reception data to be extracted, positions of reception data to be extracted, and positions of the extracted data in the sequence of transmission data.

As mentioned above, the reception buffers 11 and 14 of the GW unit in principle, store the most recent reception data. While reception data is needed to generate transmission data, an error may cause part of the reception data to be unreceived. Unreceived data may prevent the transmission data from being generated. In order to solve the above noted problem, it may be preferable to predetermine an initial value as transmission data and use the initial value as is for data generated from unreceived reception data.

A second conversion example shown and described for example in connection with FIG. 5 is a conversion process for generating transmission data when reception data and transmission data are differently sized. According to the second example, 6-bit reception data can be converted so as to be represented as 3-bit transmission data. In other words, the conversion process compresses 6-bit data into 3-bit data. For example, the conversion process extracts three high-order bits from six bits. The extracted 3-bit data constitutes one piece of transmission data. Such a conversion process can be performed, for example, when there is a resolution difference between reception data and transmission data.

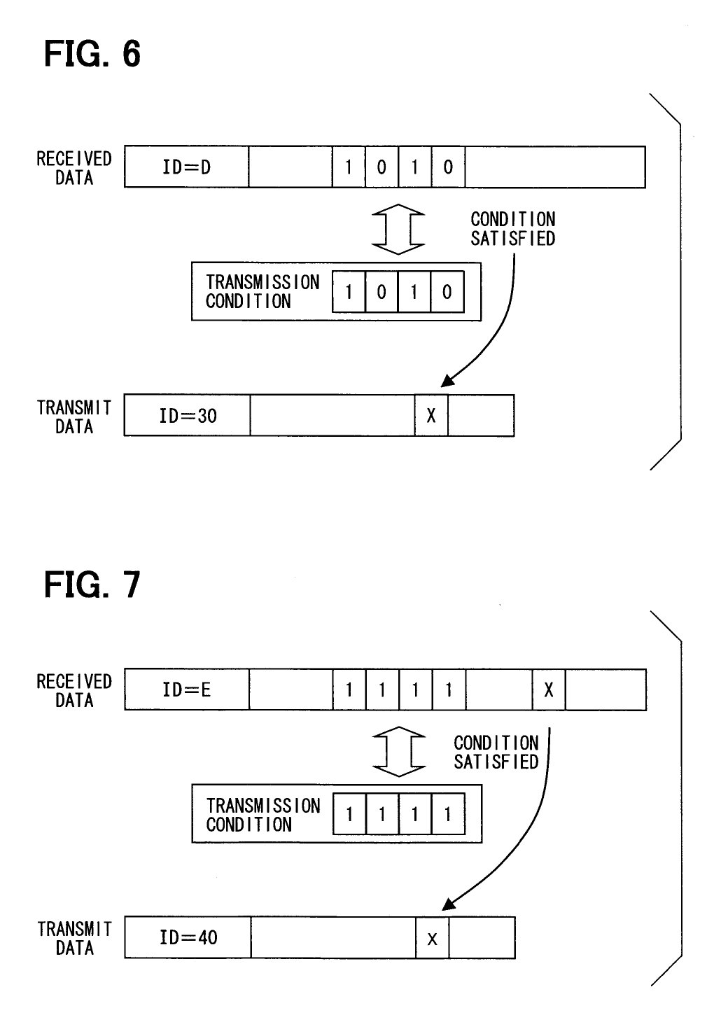

A third conversion example shown and described for example in connection with FIG. 6, is a conversion process for generating transmission data that indicates a match between a specific type of data contained in reception data and a predetermined transmission condition. Specifically, the conversion process in FIG. 6 first determines whether specific data contained in the reception data matches a value defined as a transmission condition. When a match is determined, an indicator value such as a flag set value, an arbitrary value X, or the like, indicating a successful match, is included as one piece of individual data belonging to the transmission data. The indicator value is not originally included in the reception data. When the condition is not satisfied, an initial value such as is described in connection with the first example, or the like, can be used. A conversion process in accordance with the third example can be used, for example, to notify the receiver of the transmit data that a value detected by a device or a sensor associated with the sender of the reception data reaches a given state.

A fourth conversion example shown and described for example in connection with FIG. 7, is a process that first determines whether specific data contained in the reception data matches a value defined as a transmission condition. Where the fourth conversional example differs from the third example is that when a match is determined, a specific value that is already contained in the reception data becomes one piece of individual data belonging to the transmission data.

While specific exemplary embodiments, including a preferred embodiment of the present invention, have been described herein, it is to be distinctly understood that the present invention is not limited to any particular embodiment described herein but may be otherwise variously embodied within the spirit and scope of the invention.

For example, while the first through fourth conversion examples of the data conversion section 13 are described above in accordance with various exemplary embodiments, these conversion examples are available in any combinations including the use of one, some or all of the conversion examples and use of other conversion examples not specifically described. Further, some data may be transmitted as null data when a specific value is not necessary for inclusion in the transmission data.

What is claimed is:

1. A data relay unit provided between a first and a second network each having different structures for data to be communicated, the relay unit relaying data communications between the first and the second networks, the data relay unit comprising:
a data conversion section for generating transmission data to be transmitted to one of the first and the second networks out of reception data received from the other of the first and the second networks,
wherein a specific identifier is assigned to each of the reception data and the transmission data;
wherein the data conversion section:
specifies a conversion process for using the reception data to generate transmission data for each transmission data piece identified by the identifier; and
stores the conversion process corresponding to the identifier associated with the transmission data in a conversion table; and
wherein the data conversion section generates the transmission data based on the identifier of the transmission data to be transmitted by selecting and executing the conversion process for generating the transmission data from the conversion table.

2. The data relay unit according to claim 1,
wherein the transmission data includes a plurality of pieces of individual data; and
wherein the conversion process for generating the transmission data includes a plurality of individual conversion processes each specified for the individual data.

3. The data relay unit according to claim 2,
wherein the data conversion section includes an index associated with storing an identifier of the transmission data, the index corresponding to an address range in the conversion table for storing the plurality of individual conversion processes for generating the transmission data; and
wherein the data conversion section uses the index to select a plurality of individual conversion processes corresponding to the identifier of the transmission data to be transmitted from the conversion table.

4. The data relay unit according to claim 1,
wherein the data conversion section determines an identifier of transmission data to be transmitted next based on a relay priority of reception data received from one of the first and second networks and based on a transmission result of transmission data.

5. The data relay unit according to claim 1,
wherein an initial value is used as the transmission data if the reception data is received with errors.

6. The data relay unit according to claim 1,
wherein the conversion process generates the transmission data having a first size when the reception data has a second size different from the first size.

7. The data relay unit according to claim 6,
wherein the first size is smaller than the second size

8. The data relay unit according to claim 1,
wherein the conversion process generates the transmission data indicating one of a match between a specific type of data contained in the reception data and a predetermined transmission condition.

9. The data relay unit according to claim 8,
wherein the indication is not originally included in the reception data.

10. The data relay unit according to claim 1, wherein the conversion process first determines whether specific data contained in the reception data matches a value defined as a transmission condition and, when a match is determined, a specific value that is already contained in the reception data becomes one piece of individual data belonging to the transmission data.

11. A gateway unit configured to relay data between a first and a second network, the first and the second network transmitting transmission data using different data structures through a plurality of control units, the transmission data provided with a unique identifier (ID) according to a type of the transmission data, the gateway unit comprising:
a data converter;
a reception buffer coupled to the data converter for receiving the transmission data from one of the plurality of control units associated with one of the first network and the second network as reception data, the reception buffer containing a capacity to individually store the reception data from the ones of the plurality of control units according to the unique ID; and
a transmission buffer coupled to the data converter and the reception buffer;
wherein:
the data converter performs a conversion process for generating transmission data and assigning the unique ID for the generated transmission data based on the reception data received from the one of the plurality of control units associated with the one of the first and the second networks, and stored in the reception buffer;
the transmission data generated by the data converter is placed in the transmission buffer; and
the transmission data stored in the transmission buffer is transmitted to a corresponding other one of the first and the second networks, when the gateway is provided with a transmission right.

12. The gateway unit according to claim 11, wherein the reception buffers are configured to store only reception data that needs to be relayed from the one of the plurality of control units associated with the one of the first and the second networks to the other one of the first and the second networks.

13. The gateway unit according to claim 11,
wherein the conversion process generates the transmission data having a first size when the reception data has a second size different from the first size.

14. The gateway unit according to claim 11,
wherein the conversion process generates the transmission data indicating one of a match between a specific type of data contained in the reception data and a predetermined transmission condition.

15. The gateway unit according to claim 11, wherein the conversion process first determines whether specific data contained in the reception data matches a value defined as a transmission condition and, when a match is determined, a specific value that is already contained in the reception data becomes one piece of individual data belonging to the transmission data.

16. A method for generating transmission data to be transmitted to one of a first network and a second network based on reception data received from the other of the first network and the second network, the method comprising:
determining whether the reception data has been given a high relay priority;
if the reception data has been given a high relay priority, determining an identifier of the transmission data to be transmitted based on the reception data so as to generate transmission data for relaying the reception data as transmission data to be transmitted to the one of the first and second networks; and
if the new reception data has not been given a high relay priority, determining an identifier of the transmission data to be transmitted based on a transmission result of transmission data.

17. The method according to claim 16, wherein the transmission result includes an elapsed time from the most recent transmission time point associated with the transmission data having different identifiers.

18. The method according to claim 16, further comprising referencing an index and selecting from a conversion table, a conversion process for generating the transmission data having the determined identifier.

19. The method according to claim 18,
wherein the conversion process generates the transmission data having a first size when the reception data has a second size different from the first size.

20. The method according to claim 19,
wherein the first size is smaller than the second size

21. The method according to claim 18,
wherein the conversion process generates the transmission data indicating one of a match between a specific type of data contained in the reception data and a predetermined transmission condition.

22. The method according to claim 21,
wherein the indication is not originally included in the reception data.

23. The method according to claim 18, wherein the conversion process first determines whether specific data contained in the reception data matches a value defined as a transmission condition and, when a match is determined, a specific value that is already contained in the reception data becomes one piece of individual data belonging to the transmission data.

24. The method according to claim 18, wherein the conversion table stores a plurality of conversion processes for generating transmission data identified by identifiers.
